(19) United States
(12) Patent Application Publication
(10) Pub. No.: US 2025/0083611 A1
(43) Pub. Date: Mar. 13, 2025

(54) Tool Storage Box Assembly

(71) Applicant: John Beckwith, Lanark (CA)

(72) Inventor: John Beckwith, Lanark (CA)

(21) Appl. No.: 18/243,506

(22) Filed: Sep. 7, 2023

(51) Int. Cl. B60R 9/00; B60R 11/06

(52) U.S. Cl. CPC B60R 9/00; B60R 11/06

(57) ABSTRACT

A tool storage box assembly includes a storage box defines a storage area to contain tools and chemicals commonly employed for over-the-road trucking. A door is hingedly attached to the storage box for opening and closing the storage area. The storage box has a handle storage element and a plurality of bar storage elements for storing a plurality of load bars. A handle is engageable to the handle storage element of the storage box for storing the handle. A broom head is removably attachable to the handle for sweeping and a shovel head is removably attachable to the handle to scoop material. A shelf is coupled to the storage box for storing objects employed by the driver.

### CROSS-REFERENCE TO RELATED APPLICATIONS

### Not Applicable

### STATEMENT REGARDING FEDERALLY SPONSORED RESEARCH OR DEVELOPMENT

### Not Applicable

### THE NAMES OF THE PARTIES TO A JOINT RESEARCH AGREEMENT

### Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### STATEMENT REGARDING PRIOR DISCLOSURES BY THE INVENTOR OR JOINT INVENTOR

### Not Applicable

### BACKGROUND OF THE INVENTION

### (1) Field of the Invention

The disclosure relates to storage box devices and more particularly pertains to a new storage box device for storing chemicals and tools that are commonly employed to maintain a semi-truck. The device includes a storage box which has a handle storage element and a plurality of bar storage elements for storing a handle and a plurality of load bars. The device includes a pair of brackets that area attached to the storage box which are each attachable to a frame of a semi-truck for mounting the storage box to the semi-truck. The device includes a handle, a broom head attachable to the handle for sweeping and a shovel head attachable to the handle for scooping.

### (2) Description of Related Art Including Information Disclosed Under 37 CFR 1.97 and 1.98

The prior art relates to storage box devices including a variety of tool storage box devices that can be mounted to a truck in variety of securing means and a chemical storage cabinet device. In no instance does the prior art disclose a chemical storage box which is mountable to a frame of a semi-truck and which includes a handle storage element and a plurality of bar storage elements for storing load bars.

### BRIEF SUMMARY OF THE INVENTION

An embodiment of the disclosure meets the needs presented above by generally comprising a storage box defines a storage area to contain tools and chemicals commonly employed for over-the-road trucking. A door is hingedly attached to the storage box for opening and closing the storage area. The storage box has a handle storage element and a plurality of bar storage elements for storing a plurality of load bars. A handle is engageable to the handle storage element of the storage box for storing the handle. A broom head is removably attachable to the handle for sweeping and a shovel head is removably attachable to the handle to scoop material. A shelf is coupled to the storage box for storing objects employed by the driver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tool storage box assembly according to an embodiment of the disclosure.

FIG. 2 is a bottom view of an embodiment of the disclosure.

FIG. 3 is a right side view of an embodiment of the disclosure.

FIG. 4 is a back phantom view of an embodiment of the disclosure.

FIG. 5 is a front view of an embodiment of the disclosure showing a door in an open position.

FIG. 6 is a perspective in-use view of an embodiment of the disclosure.

### DETAILED DESCRIPTION OF THE INVENTION

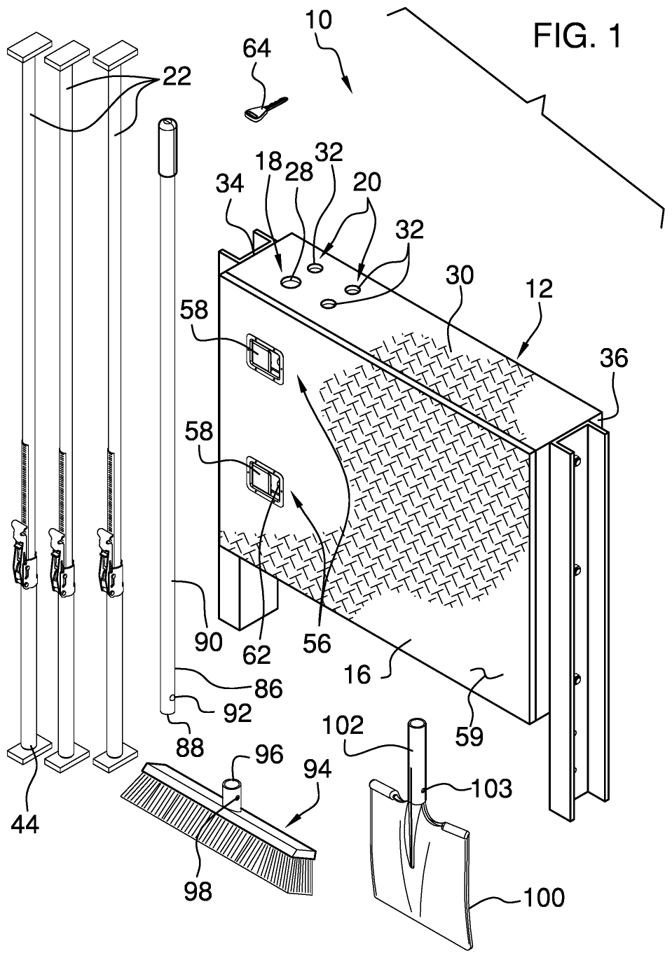

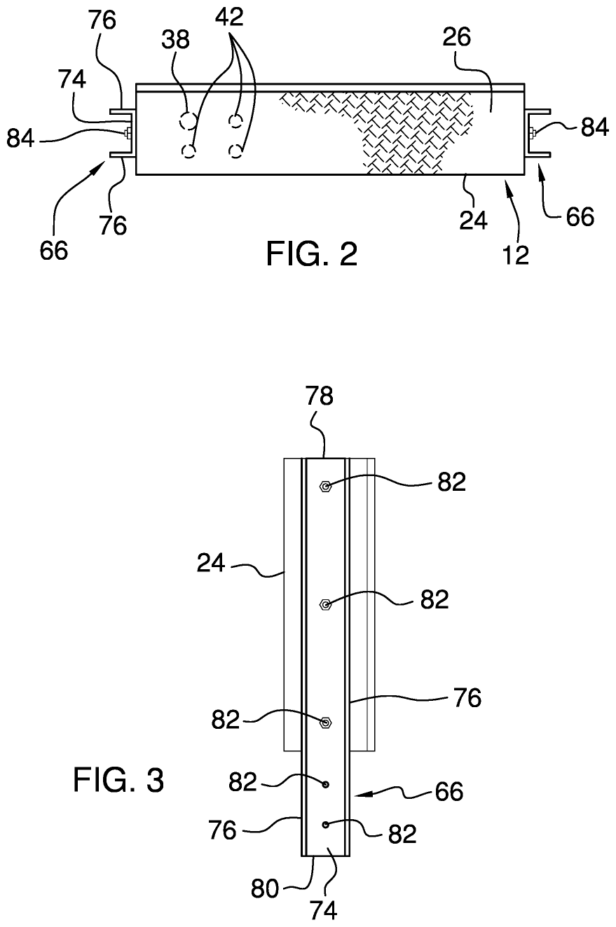

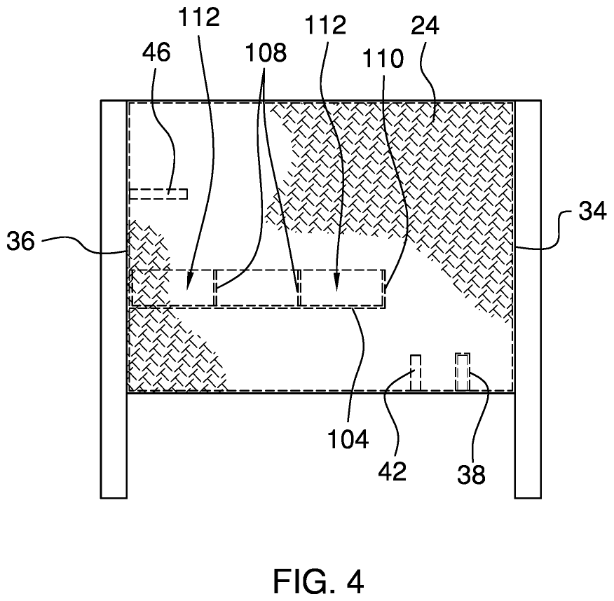

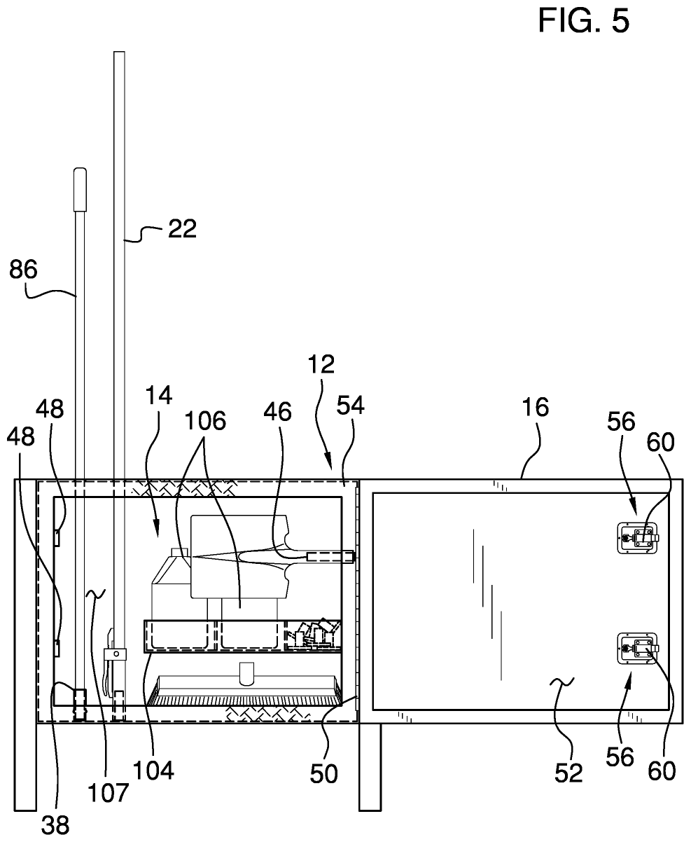

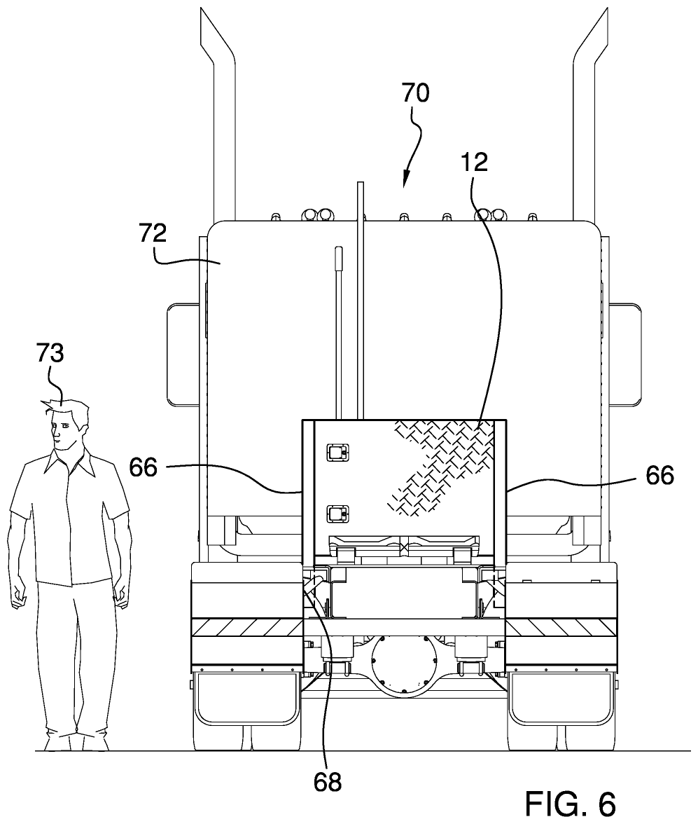

With reference now to the drawings, and in particular to FIGS. 1 through 6 thereof, a new storage box device embodying the principles and concepts of an embodiment of the disclosure and generally designated by the reference numeral 10 will be described.

As best illustrated in FIGS. 1 through 6, the tool storage box assembly 10 generally comprises a storage box 12 which defines a storage area 14 to contain tools and chemicals commonly employed for over-the-road trucking. The storage box 12 has a door 16 which is hingedly attached to the storage box 12 for opening and closing the storage area 14. The storage box 12 is comprised of a fluid impermeable material, including but not being limited to aluminum or steel, to inhibit the chemicals from leaking from the storage box 12 in the event of a leak. The chemicals might include, but not be limited to, engine coolant, engine oil and other types of chemicals that are commonly employed in the maintenance of semi-trucks. The storage box 12 has a handle storage element 18 and a plurality of bar storage elements 20 and each of the bar storage elements 20 engages a respective one of a plurality of load bars 22 for storing the plurality of load bars 22. The load bars 22 may be ratcheting load bars that are commonly employed on van trailers and refrigerated trailers for securing cargo.

The storage box 12 has a back wall 24 and an outer wall 26 extending forwardly from the back wall 24 and the outer wall 26 has a handle hole 28 extending through a top side 30 of the outer wall 26 into the storage area 14. Additionally, the outer wall 26 has a plurality of bar holes 32 each extending through the top side 30 of the outer wall 26 into the storage area 14. Each of the plurality of bar holes 32 and the handle hole 28 is arranged on the top side 30 to define a respective one of four corners of a rectangle which is positioned closer to a first lateral side 34 of the outer wall 26 than a second lateral side 36 of the outer wall 26. A cup 38 extends upwardly from a bottom side 40 of the outer wall 26 of the storage box 12 such that the cup 38 is positioned within the storage area 14. The cup 38 is aligned with the handle hole 28 such that the cup 38 and the handle hole 28 defines the handle storage element 18.

A plurality of first pegs 42 each extends upwardly from the bottom side 40 of the outer wall 26 of the storage box 12 such that each of the plurality of first pegs 42 is positioned within the storage area 14. Furthermore, each of the first pegs 42 is aligned with a respective one of the bar holes 32 such that each of the plurality of first pegs 42 and each of the plurality of bar holes 32 defines the plurality of bar storage elements 20. Each of the plurality of load bars 22 is insertable through a respective one of the bar holes 32 such that an end 44 of each of the plurality of load bars 22 insertably receives a respective one of the first pegs 42 for storing the plurality of load bars 22. A second peg 46 extends laterally away from the second lateral side 36 of the outer wall 26 of the storage box 12 such that the second peg 46 is positioned within the storage area 14. Additionally, the second peg 46 is positioned closer to the top side 30 of the outer wall 26 than the bottom side 40 of the outer wall 26.

The storage box 12 has a pair of engagements 48 each is coupled to the first lateral side 34 of the outer wall 26 of the storage box 12 having each of the engagements 48 being positioned within the storage area 14. The door 16 has a hinged edge 50 that is hingedly coupled to the second lateral side 36 of the outer wall 26 of the storage box 12. A rear surface 52 of the door 16 rests against a front edge 54 of the outer wall 26 when the door 16 is in a closed position. Furthermore, the front edge 54 of the outer wall 26 is exposed when the door 16 is in an open position.

The door 16 has a pair of locks 56 that is each movably integrated into the door 16. Each of the locks 56 includes a handle 58 that is recessed into a front surface 59 of the door 16 for gripping to urge the locks 56 into an unlocked condition. Each of the locks 56 is biased into a locked condition and each of the locks 56 includes a bolt 60 that is disposed on the rear surface 52 of the door 16. The bolt 60 associated with each of the locks 56 releasably engages a respective one of the engagements 48 for retaining the door 16 in the closed position. Conversely, the bolt 60 associated with a respective one of the locks 56 disengages the respective engagement 48 when the respective lock 56 is urged into the unlocked condition. Each of the locks 56 may include a keyhole 62 for insertably receiving a key 64 for locking the locks 56 thereby inhibiting the locks 56 from being urged into the unlocked condition.

A pair of brackets 66 is each coupled to the storage box 12 and each of the pair of brackets 66 extends downwardly from the storage box 12. In this way each of the brackets 66 can be attached to a frame 68 of a semi-truck 70 having the storage box 12 being positioned behind a sleeper cab 72 of the semi-truck 70. In this way the storage box 12 is accessible to a driver 73 of the semi-truck 70. Each of the brackets 66 has a central panel 74 extending between a pair of outward panels 76 having the outward panels 76 being oriented parallel to each other such that each of the brackets 66 has a U-shape. Additionally, each of the brackets 66 is elongated between a first end 78 and a second end 80 of the brackets 66.

The central panel 74 associated with each of the brackets 66 rests against a respective one of the first lateral side 34 and the second lateral side 36 of the outer wall 26 of the storage box 12. The first end 78 of each of the brackets 66 is aligned with the top side 30 of the outer wall 26 and the second end 80 of each of the brackets 66 is spaced from the bottom side 40 of the outer wall 26. The central panel 74 associated with each of the brackets 66 has a plurality of fastener holes 82 each extending through the central panel 74 and being distributed along the central panel 74. Respective ones of the fastener holes 82 insertably receiving a respective one of a plurality of fasteners 84 which engage the respective first lateral side 34 and the second lateral side 36 of the outer wall 26 for retaining the brackets 66 on the storage box 12. Additionally, respective ones of the fastener holes 82 which are positioned between the bottom side 40 of the outer wall 26 of the storage box 12 and the second end 80 of the brackets 66 insertably receives respective ones of a plurality of fasteners 84 which each engages the frame 68 of the semi-truck 70 for mounting the storage box 12 to the semi-truck 70.

A handle 86 is provided which is engageable to the handle storage element 18 of the storage box 12 for storing the handle 86. The handle 86 has a lower end 88 which is extendable through the handle hole 28 in the top side 30 of the outer wall 26 of the storage box 12 having the lower end 88 being inserted into the cup 38 for storing the handle 86. An exterior wall 90 of the handle 86 has a lock 92 that is biased to extend outwardly from the exterior wall 90 and the lock 92 associated with the handle 86 is positioned proximate the lower end 88.

A broom head 94 is provided which is removably attachable to the handle 86 such that the broom head 94 can be employed by the driver 74 for sweeping. The broom head 94 has a receiver 96 which extends away from the broom head 94 and which insertably receives the lower end 88 of the handle 86. The lock 92 associated with the handle 86 extends through a hole 98 in the receiver 96 for releasably retaining the broom head 94 on the handle 86. Furthermore, the receiver 96 is removable from the lower end 88 of the handle 86 when the lock 92 associated with the handle 86 is depressed. The broom head 94 is stored in the storage area 14 in the storage box 12 when the broom head 94 is not attached to the handle 86.

A shovel head 100 is provided and the shovel head 100 is removably attachable to the handle 86 to facilitate the driver 74 to scoop material. The shovel head 100 has a socket 102 for insertably receiving the lower end 88 of the handle 86 such that the lock 92 associated with the handle 86 extends through a hole 103 in the socket 102 for releasably retaining the shovel head 100 on the handle 86. The socket 102 is removable from the lower end 88 of the handle 86 when the lock 92 associated with the handle 86 is depressed. The socket 102 insertably receives the second peg 46 on the storage box 12 for storing the shovel head 100 in the storage box 12.

A shelf 104 is coupled to the storage box 12 and the shelf 104 is positioned within the storage area 14 for storing objects 106 employed by the driver 74. The objects 106 may include feet for the load bars 22, bottles of chemicals, hand tools and other items that would commonly be employed for maintaining the semi-truck 70. The shelf 104 is attached to an inwardly facing surface 107 of the back wall 24 of the storage box 12 having the shelf 104 being horizontally oriented. The shelf 104 has a plurality of dividers 108 which are surrounded by a perimeter wall 110 to define a plurality of storage spaces 112 for containing the objects 106. The shelf 104 extends from the second lateral side 36 of the outer wall 26 of the storage box 12 toward the first lateral side 34 of the outer wall 26. Additionally, the shelf 104 is positioned closer to the bottom side 40 of the outer wall 26 than the top side 30 of the outer wall 26.

In use, each of the brackets 66 is mounted to the frame 68 of the semi-truck 70 such that the storage box 12 is positioned behind the sleeper cab of the semi-truck 70. In this way the storage box 12 is accessible to the driver 74 of the semi-truck 70. Furthermore, the chemicals can be stored in the storage box 12 rather than being stored in the sleeper cab and potentially exposing the driver 74 to hazardous fumes. The broom head 94 can be attached to the handle 86 for sweeping or the shovel head 100 can be attached to the handle 86 for scooping material. In this way the driver 74 can effectively clean up nearly any type of spill associated with loading and unloading cargo. Furthermore, each of the load bars 22, the handle 86, the broom head 94 and the shovel head 100 are stored in the storage box 12 to be easily accessible to the driver 74.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tool storage box assembly for storing tools and chemicals behind a sleeper of a semi-truck, said assembly comprising:
a storage box defining a storage area wherein said storage area is configured to contain tools and chemicals commonly employed for over-the-road trucking, said storage box having a door hingedly attached to said storage box for opening and closing said storage area, said storage box being comprised of a fluid impermeable material wherein said storage box is configured to inhibit the chemicals from leaking from said storage box in the event of a leak, said storage box having a handle storage element and a plurality of bar storage elements, each of said bar storage elements engaging a respective one of a plurality of load bars for storing said plurality of load bars;
a pair of brackets, each of said pair of brackets being coupled to said storage box, each of said pair of brackets extending downwardly from said storage box thereby facilitating each of said brackets to be attached to a frame of a semi-truck having said storage box being positioned behind a cab of said semi-truck wherein said storage box is configured to be accessible to a driver of said semi-truck;
a handle being engageable to said handle storage element of said storage box for storing said handle;
a broom head being removably attachable to said handle wherein said broom head is configured to be employed by the driver for sweeping;
a shovel head being removably attachable to said handle wherein said shovel head is configured to facilitate the driver to scoop material; and
a shelf being coupled to said storage box having said shelf being positioned within said storage area for storing objects employed by the driver.

2. The assembly according to claim 1, wherein:
said storage box has a back wall and an outer wall extending forwardly from said back wall;
said outer wall has a handle hole extending through a top side of said outer wall into said storage area;
said outer wall has a plurality of bar holes each extending through said top side of said outer wall into said storage area; and
each of said plurality of bar holes and said handle hole being arranged on said top side to define a respective one of four corners of a rectangle which is positioned closer to a first lateral side of said outer wall than a second lateral side of said outer wall.

3. The assembly according to claim 2, wherein said storage box has a cup extending upwardly from a bottom side of said outer wall of said storage box such that said cup is positioned within said storage area, said cup being aligned with said handle hole such that said cup and said handle hole defines said handle storage element.

4. The assembly according to claim 3, wherein:
said storage box has a plurality of first pegs each extending upwardly from said bottom side of said outer wall of said storage box such that each of said plurality of first pegs is positioned within said storage area, each of said first pegs being aligned with a respective one of said bar holes such that each of said plurality of first pegs and each of said plurality of bar holes defines said plurality of bar storage elements; and
each of said plurality of load bars is insertable through a respective one of said bar holes such that an end of each of said plurality of load bars insertably receives a respective one of said first pegs for storing said plurality of load bars.

5. The assembly according to claim 4, wherein:
said storage box has a plurality of first pegs being disposed within said storage box; and
said storage box has a second peg extending laterally away from said second lateral side of said outer wall of said storage box such that said second peg is positioned within said storage area, said second peg being positioned closer to said top side of said outer wall than said bottom side of said outer wall.

6. The assembly according to claim 1, wherein:
said storage box has a pair of engagements each being coupled to a first lateral side of an outer wall of said storage box having each of said engagements being positioned within said storage area;
said door has a hinged edge being hingedly coupled to a second lateral side of said outer wall of said storage box;
a rear surface of said door rests against a front edge of said outer wall when said door is in a closed position, said front edge of said outer wall being exposed when said door is in an open position;
said door has a pair of locks each being movably integrated into said door;
each of said locks includes a handle being recessed into a front surface of said door for gripping to urge said locks into an unlocked condition;
each of said locks is biased into a locked condition; and
each of said locks includes a bolt being disposed on said rear surface of said door, said bolt associated with each of said locks releasably engaging a respective one of said engagements for retaining said door in said closed position, said bolt associated with a respective one of said locks disengaging said respective engagement when said respective lock is urged into said unlocked condition.

7. The assembly according to claim 1, wherein:
each of said brackets has a central panel extending between a pair of outward panels having said outward panels being oriented parallel to each other such that each of said brackets has a U-shape;
each of said brackets is elongated between a first end and a second end of said brackets; and
said central panel associated with each of said brackets rests against a respective one of a first lateral side and a second lateral side of an outer wall of said storage box having said first end of each of said brackets being aligned with a top side of said outer wall and having said second end of each of said brackets being spaced from a bottom side of said outer wall.

8. The assembly according to claim 7, wherein said central panel associated with each of said brackets has a plurality of fastener holes extending through said central panel and being distributed along said central panel, respective ones of said fastener holes insertably receiving a respective one of a plurality of fasteners which engage said respective first lateral side and said second lateral side of said outer wall for retaining said brackets on said storage box, respective ones of said fastener holes which are positioned between said bottom side of said outer wall of said storage box and said second end of said brackets insertably receiving respective ones of a plurality of fasteners which each engages said frame of said semi-truck for mounting said storage box to said semi-truck.

9. The assembly according to claim 3, wherein a lower end of said handle is extendable through said handle hole in said top side of said outer wall of said storage box having said lower end being inserted into said cup for storing said handle.

10. The assembly according to claim 1, wherein:
an exterior wall of said handle has a lock being biased to extend outwardly from said exterior wall having said lock associated with said handle being positioned proximate a lower end of said handle; and
said broom head has a receiver extending away from said broom head which insertably receives a lower end of said handle such that said lock associated with said handle extends through a hole in said receiver for releasably retaining said broom head on said handle, said receiver being removable from said lower end of said handle when said lock associated with said handle is depressed, said broom head being stored in said storage area in said storage box when said broom head is not attached to said handle.

11. The assembly according to claim 4, wherein:
an exterior wall of said handle has a lock being biased to extend outwardly from said exterior wall having said lock associated with said handle being positioned proximate a lower end of said handle; and
said shovel head has a socket for insertably receiving said lower end of said handle such that said lock associated with said handle extends through a hole in said socket for releasably retaining said shovel head on said handle, said socket being removable from said lower end of said handle when said lock associated with said handle is depressed, said socket insertably receiving said second peg on said storage box for storing said shovel head in said storage box.

12. The assembly according to claim 1, wherein:
said storage box has a back wall and an outer wall, said outer wall having a top side and a bottom side and a first lateral side and a second lateral side; and
said shelf is attached to an inwardly facing surface of a back wall of said storage box having said shelf being horizontally oriented, said shelf having a plurality of dividers being surrounded by a perimeter wall to define a plurality of storage spaces for containing said objects, said shelf extending from said second lateral side of said outer wall of said storage box toward said first lateral side of said outer wall, said shelf being positioned closer to said bottom side of said outer wall than said top side of said outer wall.

13. A tool storage box assembly for storing tools and chemicals behind a sleeper of a semi-truck, said assembly comprising:
a storage box defining a storage area wherein said storage area is configured to contain tools and chemicals commonly employed for over-the-road trucking, said storage box having a door hingedly attached to said storage box for opening and closing said storage area, said storage box being comprised of a fluid impermeable material wherein said storage box is configured to inhibit the chemicals from leaking from said storage box in the event of a leak, said storage box having a handle storage element and a plurality of bar storage elements, each of said bar storage elements engaging a respective one of a plurality of load bars for storing said plurality of load bars, said storage box having a back wall and an outer wall extending forwardly from said back wall, said outer wall having a handle hole extending through a top side of said outer wall into said storage area, said outer wall having a plurality of bar holes each extending through said top side of said outer wall into said storage area, each of said plurality of bar holes and said handle hole being arranged on said top side to define a respective one of four corners of a rectangle which is positioned closer to a first lateral side of said outer wall than a second lateral side of said outer wall, said storage box having a cup extending upwardly from a bottom side of said outer wall of said storage box such that said cup is positioned within said storage area, said cup being aligned with said handle hole such that said cup and said handle hole defines said handle storage element, said storage box having a plurality of first pegs each extending upwardly from said bottom side of said outer wall of said storage box such that each of said plurality of first pegs is positioned within said storage area, each of said first pegs being aligned with a respective one of said bar holes such that each of said plurality of first pegs and each of said plurality of bar holes defines said plurality of bar storage elements, each of said plurality of load bars being insertable through a respective one of said bar holes such that an end of each of said plurality of load bars insertably receives a respective one of said first pegs for storing said plurality of load bars, said storage box having a second peg extending laterally away from said second lateral side of said outer wall of said storage box such that said second peg is positioned within said storage area, said second peg being positioned closer to said top side of said outer wall than said bottom side of said outer wall, said storage box having a pair of engagements each being coupled to said first lateral side of said outer wall of said storage box having each of said engagements being positioned within said storage area, said door having a hinged edge being hingedly coupled to said second lateral side of said outer wall of said storage box, a rear surface of said door resting against a front edge of said outer wall when said door is in a closed position, said front edge of said outer wall being exposed when said door is in an open position, said door having a pair of locks each being movably integrated into said door, each of said locks including a handle being recessed into a front surface of said door for gripping to urge said locks into an unlocked condition, each of said locks being biased into a locked condition, each of said locks including a bolt being disposed on said rear surface of said door, said bolt associated with each of said locks releasably engaging a respective one of said engagements for retaining said door in said closed position, said bolt associated with a respective one of said locks disengaging said respective engagement when said respective lock is urged into said unlocked condition;
a pair of brackets, each of said pair of brackets being coupled to said storage box, each of said pair of brackets extending downwardly from said storage box thereby facilitating each of said brackets to be attached to a frame of a semi-truck having said storage box being positioned behind a cab of said semi-truck wherein said storage box is configured to be accessible to a driver of said semi-truck, each of said brackets having a central panel extending between a pair of outward panels having said outward panels being oriented parallel to each other such that each of said brackets has a U-shape, each of said brackets being elongated between a first end and a second end of said brackets, said central panel associated with each of said brackets resting against a respective one of said first lateral side and said second lateral side of said outer wall of said storage box having said first end of each of said brackets being aligned with said top side of said outer wall and having said second end of each of said brackets being spaced from said bottom side of said outer wall, said central panel associated with each of said brackets having a plurality of fastener holes extending through said central panel and being distributed along said central panel, respective ones of said fastener holes insertably receiving a respective one of a plurality of fasteners which engage said respective first lateral side and said second lateral side of said outer wall for retaining said brackets on said storage box, respective ones of said fastener holes which are positioned between said bottom side of said outer wall of said storage box and said second end of said brackets insertably receiving respective ones of a plurality of fasteners which each engages said frame of said semi-truck for mounting said storage box to said semi-truck;
a handle being engageable to said handle storage element of said storage box for storing said handle, said handle having a lower end which is extendable through said handle hole in said top side of said outer wall of said storage box having said lower end being inserted into said cup for storing said handle, an exterior wall of said handle having a lock being biased to extend outwardly from said exterior wall having said lock associated with said handle being positioned proximate said lower end;
a broom head being removably attachable to said handle wherein said broom head is configured to be employed by the driver for sweeping, said broom head having a receiver extending away from said broom head which insertably receives said lower end of said handle such that said lock associated with said handle extends through a hole in said receiver for releasably retaining said broom head on said handle, said receiver being removable from said lower end of said handle when said lock associated with said handle is depressed, said broom head being stored in said storage area in said storage box when said broom head is not attached to said handle;
a shovel head being removably attachable to said handle wherein said shovel head is configured to facilitate the driver to scoop material, said shovel head having a socket for insertably receiving said lower end of said handle such that said lock associated with said handle extends through a hole in said socket for releasably retaining said shovel head on said handle, said socket being removable from said lower end of said handle when said lock associated with said handle is depressed, said socket insertably receiving said second peg on said storage box for storing said shovel head in said storage box; and
a shelf being coupled to said storage box having said shelf being positioned within said storage area for storing objects employed by the driver, said shelf being attached to an inwardly facing surface of said back wall of said storage box having said shelf being horizontally oriented, said shelf having a plurality of dividers being surrounded by a perimeter wall to define a plurality of storage spaces for containing said objects, said shelf extending from said second lateral side of said outer wall of said storage box toward said first lateral side of said outer wall, said shelf being positioned closer to said bottom side of said outer wall than said top side of said outer wall.
